(19) United States
(12) Patent Application Publication
(10) Pub. No.: US 2009/0103032 A1
(43) Pub. Date: Apr. 23, 2009

(54) OPTICALLY COMPENSATED BEND LIQUID CRYSTAL DISPLAY

(75) Inventors: Wen-Jui Liao, Taichung County (TW); Yi-Chun Wu, Hualien County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: WINTEK CORPORATION, Taichung (TW)

(21) Appl. No.: 12/256,449

(22) Filed: Oct. 22, 2008

(30) Foreign Application Priority Data
Oct. 23, 2007 (TW) 96139711

(51) Int. Cl. G02F 1/1333

(52) U.S. Cl. 349/138

(57) ABSTRACT

An optically compensated bend (OCB) liquid crystal display (LCD) panel is provided. The OCB LCD panel includes an active device array substrate, an opposite substrate, an OCB liquid crystal layer and a first patterned dielectric layer. The opposite substrate is disposed opposite to the active device array substrate, while the OCB liquid crystal layer is disposed between the active device array substrate and the opposite substrate. Besides, the first patterned dielectric layer is disposed on the active device array substrate. It is noted that the first patterned insulator has at least a first concave and at least a first transition surface corresponding thereto, such that an arrangement of the liquid crystal molecules of the OCB liquid crystal layer above the first transition surface is a hybrid state. In the above-mentioned OCB LCD panel, the OCB liquid crystal layer can be transited from a splay state to a bend state rapidly.

### CROSS-REFERENCE TO RELATED APPLICATION

This application claims the priority benefit of Taiwan application serial no. 96139711, filed on Oct. 23, 2007. The entirety of the above-mentioned patent application is hereby incorporated by reference herein and made a part of specification.

### BACKGROUND OF THE INVENTION

1. Field of the Invention

The present invention relates to a liquid crystal display (LCD) panel. More particularly, the present invention relates to an optically compensated bend (OCB) LCD.

2. Description of Related Art

LCDs are mainly classified into different types according to liquid crystal molecules, driving method and disposed position of light source etc. An OCB LCD has a feature of fast response, and the response time thereof may be less than 5ms. Therefore, smooth image performance may be achieved when rapidly changed continuous images such as a cartoon or a movie are played on the OCB LCD, and accordingly such LCD is quite suitable in application of high-end LCDs. However, only when the OCB liquid crystal molecules are transited from a splay state into a bend state, may the OCB LCD enter into a display state for providing a fast response performance.

FIG. 1A is a schematic diagram of OCB liquid crystal molecules with a splay state. FIG. 1B is a schematic diagram of OCB liquid crystal molecules with a bend state. Referring to FIG. 1A and FIG. 1B, a conventional OCB LCD panel 100 has a plurality of OCB liquid crystal molecules between an opposite substrate 110 and an active device array substrate 120. The opposite substrate 110 has a common electrode 112, and the active device array substrate 120 has a plurality of pixel electrodes 122 (only one is shown). As shown in FIG. 1A, when no bias is applied between the common electrode 112 and the pixel electrode 122, the OCB liquid crystal molecules is arranged in the splay state without affection of an external electric field. However, as shown in FIG. 1B, when a bias is applied between the common electrode 112 and the pixel electrodes 122 to provide a transition electric field E vertical to the opposite substrate 110 and the active device array substrate 120, the OCB liquid crystal molecules 130 are gradually transited into the bend state.

However, to normally drive the conventional OCB LCD panel 100, a relatively long time is required for performing the above transition process, in other words, before the OCB LCD panel 100 enters into the display state, a relatively long time is required for warming up. Therefore, an immediate turn-on and display feature of the OCB LCD 100 cannot be easily achieved. Thus, to make it acceptable to consumers, fast transition of the OCB LCD panel 100 is necessary.

Generally, there are several methods that may achieve the fast transition of the OCB liquid crystal molecules from the splay state to the bend state. One of the methods is to apply an ultra high voltage between the opposite substrate 110 and the active device array substrate 120 for generating the electric field E. As shown in FIG. 1B, under the affection of the high transition electric field E after the high voltage is applied, the OCB liquid crystal molecules 130 may be rapidly transited from the splay state to the bend state. However, the source drivers utilized under such method for applying the ultra high voltage are relatively less, and power consumption thereof is relatively high. Moreover, if the transition time of the liquid crystal molecules is insufficient, it may cause an inadequate transition, and accordingly the display effect of the LCD is affected.

The second method is to irradiate an alignment film via ultraviolet for changing the characteristic of the alignment film, so as to increase the pre-tilt angle of the OCB liquid crystal molecules. Specifically, by adding polymer sensitive to the ultraviolet into the alignment film, and irradiating the alignment film by the ultraviolet, the OCB liquid crystal molecules may be pre-tilted. In other words, the optical axis of the liquid crystal molecule is controlled to have a pre-tilt angle with a direction of the electric field, such that elasticity may be rapidly transmitted among the OCB liquid crystal molecules. However, steps of pre-tilting the OCB liquid crystal molecules by irradiation are relatively complicated, and the materials and fabrication equipment of the photosensitive alignment film are still immature. Therefore, mass production thereof is difficult.

The third method is based on a special pixel design, by which a bended electric field may be formed within a part of region of the pixels to accelerate transition of the OCB liquid crystal molecules. According to this method, a slit is formed on the pixel electrode or the common electrode to change the direction of the electric field, so as to form a bended electric field to accelerate transition of the OCB liquid crystal molecules. However, pixel design of this method is relatively complicated, and fabrication difficulty is rather high. Moreover, control of the liquid crystal molecules on the slit is difficult, so that the display effect is affected. If the slit is shielded, an aperture ratio of the LCD panel is further affected. Therefore, rapid and full transition of the OCB liquid crystal molecules without increasing a fabrication difficulty is still a major subject under developing.

### SUMMARY OF THE INVENTION

Accordingly, the present invention is directed to an optically compensated bend (OCB) LCD panel, by which OCB liquid crystal molecules may be rapidly and fully transited to a bend state.

The present invention provides an OCB LCD panel including an active device array substrate, an opposite substrate, an OCB liquid crystal layer and a first patterned dielectric layer. The opposite substrate is disposed opposite to the active device array substrate, while the OCB liquid crystal layer is disposed between the active device array substrate and the opposite substrate. Besides, the first patterned dielectric layer is disposed on the active device array substrate. It is noted that the first patterned dielectric layer has at least a first transition surface, and an arrangement of the OCB liquid crystal molecules of the OCB liquid crystal layer above the first transition surface is a hybrid state, which is between a splay state and a bend state.

In an embodiment of the present invention, the OCB LCD panel further includes an alignment film disposed on the active device array substrate and the opposite substrate, and the alignment film covers the first patterned dielectric layer.

In an embodiment of the present invention, the active device array substrate includes a plurality of display regions and a plurality of non-display regions located outside the display regions. Meanwhile, the first patterned dielectric layer may have at least a first concave located in the display regions or the non-display regions.

In an embodiment of the present invention, the first concave may have a plurality of first side surfaces, and a part of the side surfaces is the first transition surface. Moreover, a first angle is formed between the first side surfaces and the active device array substrate, wherein the first angle is an acute angle.

In an embodiment of the present invention, the first angles formed between the first side surfaces and the active device array substrate may be the same or different.

In an embodiment of the present invention, a shape of the first concave may be strip, and a shape of the first side surface may be arc.

In an embodiment of the present invention, the active device array substrate includes a plurality of scan lines, a plurality of data lines, a plurality of active devices and a plurality of pixel electrodes electrically connected to the active devices. The scan lines, the data lines and the active devices may be disposed within the non-display regions, a part of the first concaves are disposed corresponding to at least one of the scan lines and the data lines, and the pixel electrodes may cover a part of the first side surfaces.

In an embodiment of the present invention, the OCB LCD panel further includes a light-shielding pattern disposed on the active device array substrate, and the light-shielding pattern may be simultaneously disposed at both sides of the scan lines and the data lines. On the other hand, the light-shielding pattern may be only disposed on both sides of the scan lines or both sides of the data lines.

In an embodiment of the present invention, the active device array substrate further includes a storage capacitor disposed in the non-display region, and a part of the first concaves are disposed corresponding to the storage capacitors.

In an embodiment of the present invention, the opposite substrate includes a black matrix layer and a plurality of color filters. The black matrix layer may be disposed corresponding to the non-display regions, and the color filters may be disposed corresponding to the display regions.

In an embodiment of the present invention, the OCB LCD panel further includes a second patterned dielectric layer disposed on the opposite substrate. The opposite substrate may have a common electrode disposed on the second patterned dielectric layer.

In an embodiment of the present invention, the second patterned dielectric layer has at least a second concave disposed corresponding to the black matrix layer or the color filters. The second concave is similar to the first concave, and has a plurality of second side surfaces, wherein a part of the second side surfaces may be a second transition surface. Moreover, a second angle is formed between each second side surface and the opposite substrate, wherein the second angle is an acute angle. The second angles formed between the second side surfaces and the opposite substrate may be the same or different. Furthermore, a shape of the second concave may be strip, and a shape of the second side surface may be arc.

Further, the present invention provides another OCB LCD panel including an active device array substrate, an opposite substrate, an OCB liquid crystal layer and a patterned dielectric layer. The opposite substrate is disposed opposite to the active device array substrate, while the OCB liquid crystal layer is disposed between the active device array substrate and the opposite substrate. Besides, the patterned dielectric layer is disposed on the opposite substrate. It is noted that the patterned dielectric layer has at least a transition surface, and an arrangement of the OCB liquid crystal molecules of the OCB liquid crystal layer above the transition surface is a hybrid state, which is between a splay state and a bend state.

In an embodiment of the present invention, the OCB LCD panel further includes an alignment film disposed on the active device array substrate and the opposite substrate, and the alignment film covers the patterned dielectric layer.

In an embodiment of the present invention, the opposite substrate includes a black matrix layer and a plurality of color filters. The patterned dielectric layer may have at least a concave disposed corresponding to the black matrix or the color filters. Moreover, the opposite substrate may have a common electrode covering the patterned dielectric layer.

In an embodiment of the present invention, the concave has at least a side surface, wherein a part of the side surfaces may be the transition surface. Moreover, an angle is formed between each side surface and the opposite substrate, wherein the angle is an acute angle. It is noted that the angles formed between the side surfaces of the concaves and the opposite substrate may be the same or different. In an embodiment of the present invention, a shape of the concave may be strip, and a shape of the side surface may be arc.

In the present invention, by applying a design of patterned dielectric layer and providing a transition surface, an arrangement of the OCB liquid crystal molecules of the OCB liquid crystal layer may have a hybrid state, which is between a splay state and a bend state. Therefore, arrangement of the OCB liquid crystal molecules of the OCB liquid crystal layer may be easily and fully transited to the bend state for displaying. Namely, The OCB LCD panel according to the present invention may rapidly enter a display state, so as to match requirements of swiftness and convenience.

In order to make the aforementioned and other objects, features and advantages of the present invention comprehensible, a preferred embodiment accompanied with figures is described in detail below.

### BRIEF DESCRIPTION OF THE DRAWINGS

FIG. 1A is a schematic diagram of OCB liquid crystal molecules with a splay state.

FIG. 1B is a schematic diagram of OCB liquid crystal molecules with a bend state.

FIG. 2A is a cross-sectional view of an OCB LCD panel according to a first embodiment of the present invention.

FIG. 2B and FIG. 2C are top views of active device array substrates of two OCB LCD panels according to a first embodiment of the present invention.

FIG. 3 is a cross-sectional view of an OCB LCD panel according to a second embodiment of the present invention.

FIG. 4 is a cross-sectional view of an OCB LCD panel according to a third embodiment of the present invention.

### DESCRIPTION OF EMBODIMENTS

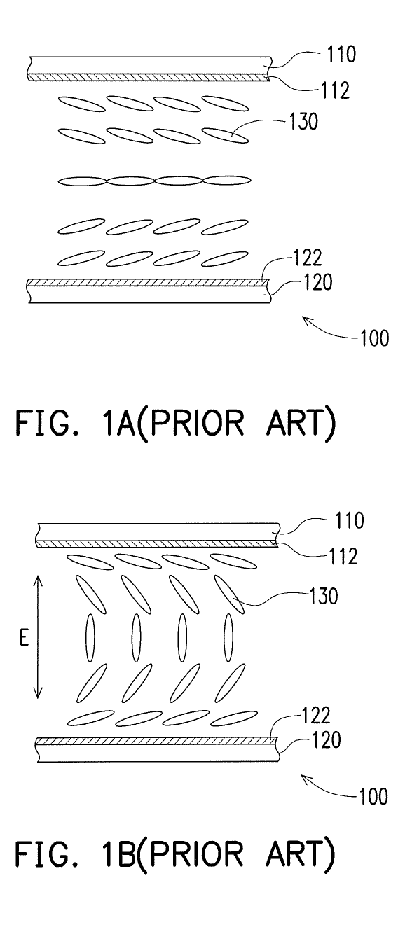

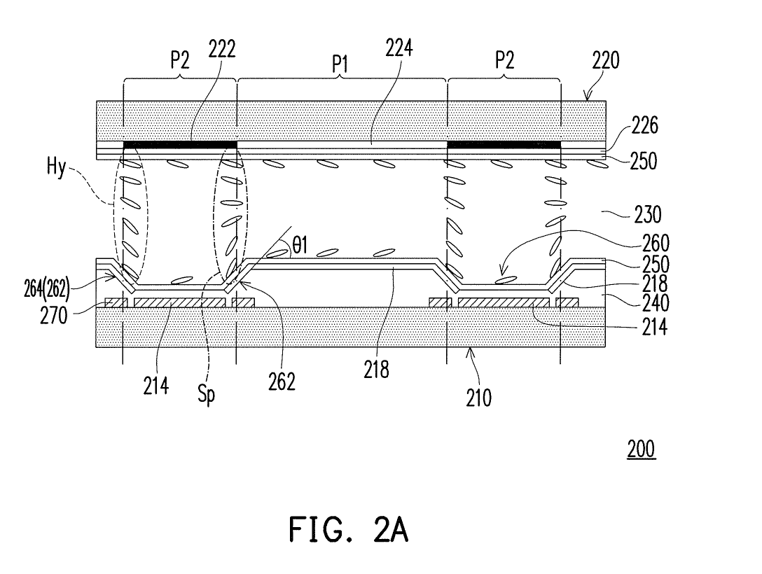

An OCB LCD has an advantage of fast response, and is suitable for displaying dynamic images. Therefore, the OCB LCD plays an important role in research and development of LCDs. However, when OCB liquid crystal molecules are about to display an image, arrangement of the OCB liquid crystal molecules should first has a bend state as shown in FIG. 1B. To rapidly and fully transit the OCB liquid crystal molecules into the bend state, a LCD panel structure is provided according to embodiments of the present invention, by which a transition core is provided for the OCB liquid crystal molecules, such that an arrangement of the OCB liquid crystal molecules above the transition core may have a hybrid state. Therefore, transition time for the OCB liquid crystal molecules being fully transited into the bend state may be effectively reduced, and meanwhile extra complicated fabrication processes are unnecessary.

To be specific, the embodiments of the invention disclose an OCB LCD panel including at least a patterned dielectric layer for providing a suitable transition surface, such that the arrangement of the OCB liquid crystal molecules may be simultaneously the hybrid state and a splay state, and arrangement of the OCB liquid crystal molecules may be easily transited to the bend state.

### First Embodiment

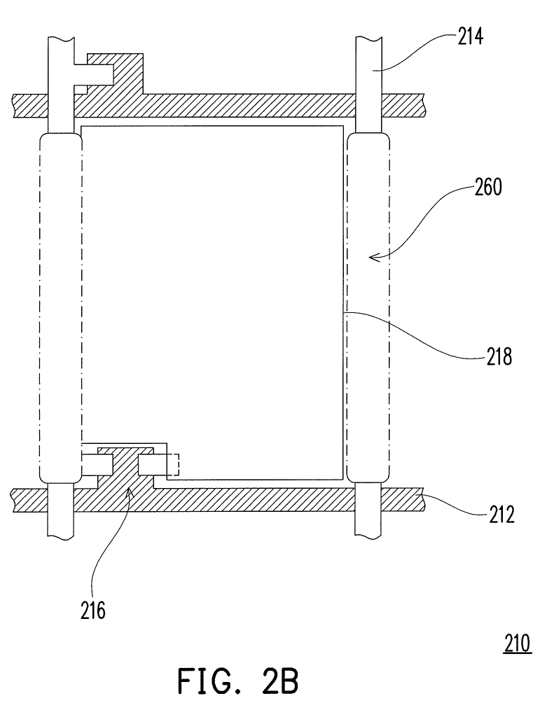

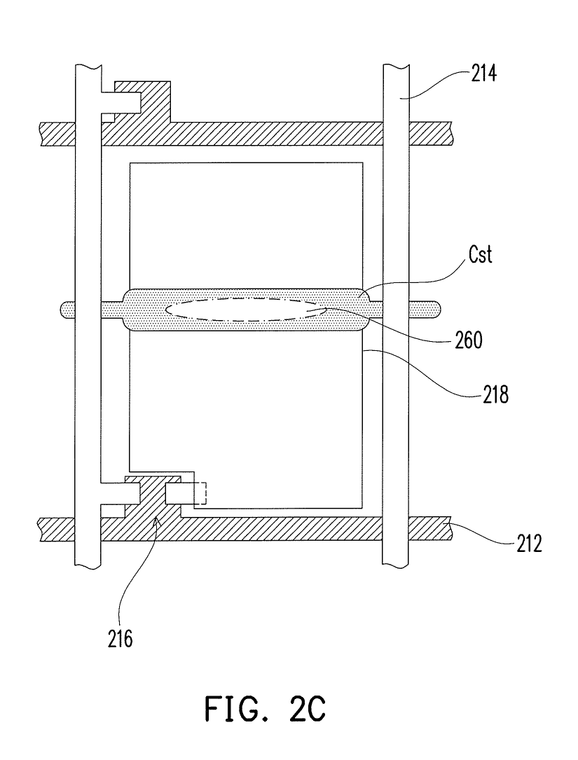

FIG. 2A is a cross-sectional view of an OCB LCD panel according to a first embodiment of the present invention. Referring to FIG. 2A, an OCB LCD panel 200 includes an active device array substrate 210, an opposite substrate 220, an OCB liquid crystal layer 230 and a first patterned dielectric layer 240. The opposite substrate 220 is disposed opposite to the active device array substrate 210, while the OCB liquid crystal layer 230 is disposed between the active device array substrate 210 and the opposite substrate 220. Besides, the first patterned dielectric layer 240 is disposed on the active device array substrate 210. It is noted that the first patterned dielectric layer 240 has at least a first transition surface 264, and an arrangement of the OCB liquid crystal molecules of the OCB liquid crystal layer 230 above the first transition surface 264 is a hybrid state Hy, which is a state between a splay state Sp and a bend state (as shown in FIG. 1B).

In the present embodiment, alignment films 250 are disposed on the active device array substrate 210 and the opposite substrate 220, and the alignment film 250 on the active device array substrate 210 covers the first patterned dielectric layer 240. Generally, the alignment films 250 applied on the two substrate (210 and 220) may have alignment patterns with the same rubbing direction, such that the arrangement of the OCB liquid crystal molecules is a splay state as shown in FIG. 1A.

Moreover, the active device array substrate 210 may have a plurality of display regions P1 and a plurality of non-display regions P2 located outside the display regions P1. In the present embodiment, the display region P1 is a region within the OCB LCD panel 200 where light may penetrate through, and display may be performed thereby; while the non-display region P2 is a region where light is blocked, and display cannot be performed thereby.

FIG. 2B is a top view of the active device array substrate 210 of the OCB LCD panel 200 according to the first embodiment of the present invention. Referring to FIG. 2A and FIG. 2B, the active device array substrate 210 includes a plurality of scan lines 212 (not shown in FIG. 2A), a plurality of data lines 214, a plurality of active devices 216 (not shown in FIG. 2A) and a plurality of pixel electrodes 218 electrically connected to the active devices 216. The scan lines 212, the data lines 214 and the active devices 216 may be made of opaque materials, and are disposed within the non-display regions P2.

Referring to FIG. 2A, the opposite substrate 220 includes a black matrix layer 222 and a plurality of color filters 224. The black matrix 222 may be disposed corresponding to the non-display regions P2, and the color filters 224 may be disposed corresponding to the display regions P1. Moreover, the opposite substrate 220 has a common electrode 226.

In the present embodiment, the first patterned dielectric layer 240 may have a first concave 260 disposed within the non-display regions P2, and a part of the first concaves 260 may be disposed corresponding to the data lines 214. Actually, the first concave 260 has a plurality of first side surfaces 262, and the pixel electrodes 218 may cover a part of the first side surfaces 262. Moreover, a first angle θ1 is formed between the first side surfaces 262 and the active device array substrate 210, and the first angle may be an acute angle.

Since the first concave 260 on the first patterned dielectric layer 240 has a plurality of the first side surfaces 262 tilting to the active device array substrate 210, the arrangement of the OCB liquid crystal molecules is tilted accordingly. Therefore, arrangement of the liquid crystal molecules located above a part of the first side surfaces 262 may be the hybrid state Hy, and these first side surfaces 262 then may be regarded as the first transition surface 264 (as shown in FIG. 2A) where the arrangement of the OCB liquid crystal molecules may be changed.

In addition, the first angle θ1 is formed between the first side surface 262 and the active device array substrate 210, and when a voltage is applied, a bend electric field is formed between the pixel electrode 218 covering a part of the first side surface 262 and the common electrode 226 located on the opposite substrate 220. Therefore, under affection of bend electric field, the liquid crystal molecules of the OCB liquid crystal layer 230 may easily enter the bend state for displaying images. Generally, there is an 8⁰ angle between the alignment film 250 and the liquid crystal molecules of the OCB liquid crystal layer 230 contacted with the alignment film 250. For example, if the first angle θ1 formed between the first side surface 262 and the active device array substrate 210 is 60⁰, an angle formed between the liquid crystal molecules of the OCB liquid crystal layer 230 near the first transition surface 264 and the active device array substrate 210 would be about 52⁰(60⁰−8⁰=52⁰). Meanwhile, an angle formed between the liquid crystal molecules of the OCB liquid crystal layer 230 and the opposite substrate 220 is still about 8⁰. That is, the liquid crystal molecules located at two sides of the OCB liquid crystal layer 230 respectively have different tilting angles with the active device array substrate 210 and the opposite substrate 220. In other words, the arrangement of the liquid crystal molecules is already the hybrid state Hy before a voltage is applied to the OCB LCD panel 200. Whenever the OCB liquid crystal layer 230 is affected under the bend electric field, the liquid crystal molecules with the hybrid state Hy may be rapidly transited to the bend state.

In another embodiment, a part of the first concaves 260 may also be disposed corresponding to at least one of the scan lines 212 and data lines 214. Actually, the first concaves 260 may also be disposed within the display regions P1. When the first concaves 260 are located within the display regions P1, the inclined part thereof, i.e. the first side surface 262 may still arrange the OCB liquid crystal molecules in the hybrid state Hy. Now, the bend electric field may still be generated between the pixel electrodes 218 covering the first concaves 260 and the common electrode 226, which avail for the arrangement of the OCB liquid crystal molecules being transited to the bend state for displaying.

Generally, there is an acute angle formed between the first side surface 262 and the active device array substrate 210, and under affection of the aforementioned bend electric field, control of the liquid crystal molecules located above the side surface 262 is difficult, which may cause a light leakage during image display. To improve the aperture ratio and display effect of the OCB LCD panel 200, the first surface 262 is preferably disposed in the non-display regions P2 where light cannot pass through. In the present embodiment, the OCB LCD panel 200 may further include a light-shielding pattern 270 disposed on the active device array substrate 210, and the light-shielding pattern 270 may be disposed at both side of the scan lines 212. However, if the first concaves 260 are disposed above the scan lines 212, or is disposed above both of the scan lines 212 and the data lines 214, the light-shielding pattern 270 may be disposed only at two sides of the scan lines 212, or at two sides of both of the scan lines 212 and the data lines 214. Based on design of the light-shielding pattern 270, difficult controlling of the OCB liquid crystal molecules due to tilting of the first surfaces 262 may be improved, and accordingly a better display effect of the OCB LCD panel 200 is achieved.

Shape of the first concave 260 may have different designs. For example, the first angles θ1 formed between the first side surfaces 262 of the first concaves 260 and the active device array substrate 210 may be different. In other words, the first side surface 262 may include more than one turning surfaces. Moreover, the first angles θ1 formed between the first side surfaces 262 of the first concaves 260 and the active device array substrate 210 may be the same or different. In other words, the first side surfaces 262 of the first concaves 260 may be symmetrical or asymmetrical. Actually, the shape of each of the first concaves 260 may be strip, and a shape of each of the first side surfaces 262 may be arc.

Furthermore, to further improve the display effect of the LCD, the active device array substrate 210 may further include a storage capacitor Cst disposed within the non-display region P2 (shown as FIG. 2C). In this case, the first concave 260 is disposed corresponding to the storage capacitor Cst for providing the suitable first transition surface 264 for the OCB liquid crystal molecules. By such means, the OCB LCD panel 200 may have a relatively fast response and a better display effect.

In the OCB LCD panel 200 of the present invention, the first transition surface 264 for the liquid crystal molecules is provided based on the design of the patterned dielectric layer 240, and aperture fabrication on the pixel electrodes is unnecessary. Therefore, aperture ratio of the OCB LCD panel 200 is not affected. Moreover, the patterned dielectric layer 240 may be fabricated by current fabrication process. For example, an organic dielectric layer may first be coated on a substrate whereon the patterned dielectric layer is about to be fabricated, and then the organic dielectric layer is patterned through a lithography and etching process, so as to form the patterned dielectric layer. Therefore, fabrication process of the OCB LCD panel of the present invention is compatible with current fabrication process.

### Second Embodiment

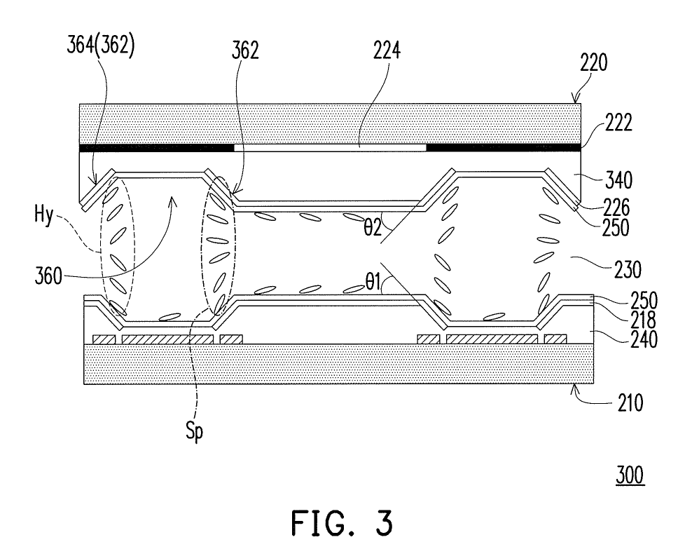

FIG. 3 is a cross-sectional view of an OCB LCD panel according to the second embodiment of the present invention. Referring to FIG. 3, an OCB LCD panel 300 is similar to the OCB LCD panel 200 of the first embodiment, only differences between the OCB LCD panel 300 and the OCB LCD panel 200 are described here. The differences therebetween is that the OCB LCD panel 300 further includes a second patterned dielectric layer 340 disposed on the opposite substrate 220. Moreover, the common electrode 226 on the opposite substrate 220 covers the second patterned dielectric layer 340.

The second patterned dielectric layer 340 may include at least a second concave 360 disposed corresponding to the black matrix layer 222 or the color filters 224 (in the embodiment shown in FIG. 3, the second concave 360 is disposed corresponding to the black matrix layer 222). It should be noted that the second concave 360 is similar to the aforementioned first concave 260, and also includes a plurality of second side surfaces 362, and a part of the second surfaces 362 may be a second transition surface 364. Moreover, a second angle θ2 which is an acute angle is formed between each of the second side surfaces 362 and the opposite substrate 220, and the second angles θ2 formed between the second side surfaces 362 of a single second concave 360 and the opposite substrate 220 may be the same or different. Similar to the first concave 260, the second side surfaces 362 of the single second concave 360 may be symmetrical or asymmetrical. Further, the shape of each of the second concaves 360 may be strip, and the shape of each of the second side surfaces 362 may be arc.

Arrangement of the liquid crystal molecules within the liquid crystal layer 230 of the OCB LCD panel 300 may simultaneously have the hybrid state Hy and the splay state Sp, and therefore as long as an impulse voltage (for example about 10 volts) is input between the pixel electrodes 218 located around the first transition surface 264 and the common electrode 226, the second transition surface 264 may then function as a transition core for propelling the liquid crystal molecules to be rapidly and fully transited into the bend state. Especially when the shape of the first concave 260 or the second concave 360 is strip, and when the transition surfaces 264 and 364 are located along the long side of the strip, the transition surfaces 264 and 364 with relatively large area then may be provided, such that arrangement of the liquid crystal molecules may be rapidly and fully transited into the bend state. Therefore, only a very short warming-up time is required by the OCB LCD panel 300 for displaying images, and a better display effect may be obtained. Moreover, fabrication processes of the first patterned dielectric layer 240 and the second patterned dielectric layer 340 are compatible with current fabrication process of the LCD panel.

### Third Embodiment

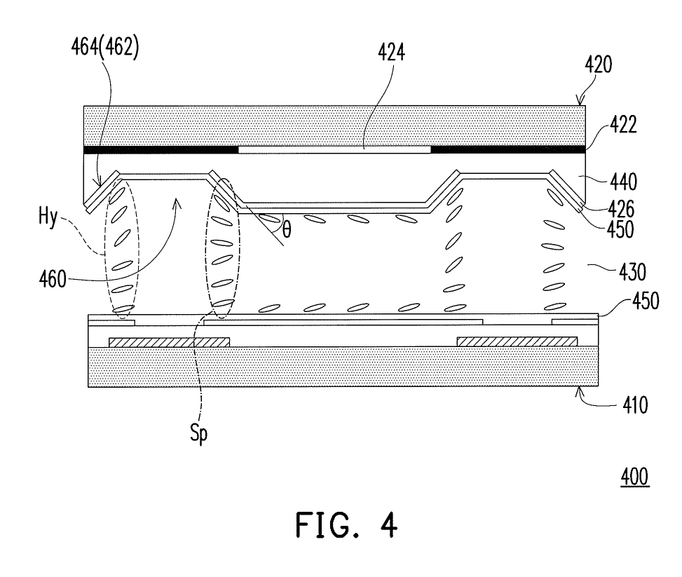

FIG. 4 is a cross-sectional view of an OCB LCD panel according to the third embodiment of the present invention. Referring to FIG. 4, an OCB LCD panel 400 includes an active device array substrate 410, an opposite substrate 420, an OCB liquid crystal layer 430 and a patterned dielectric layer 440. The opposite substrate 420 is disposed opposite to the active device array substrate 410, while the OCB liquid crystal layer 430 is disposed between the active device array substrate 410 and the opposite substrate 420. Besides, the patterned dielectric layer 440 is disposed on the opposite substrate 420. It is noted that the patterned dielectric layer 440 has at least one transition surface 464, and an arrangement of the OCB liquid crystal molecules of the OCB liquid crystal layer 430 above the transition surface 464 is a hybrid state, which is between a splay state and a bend state.

In the present embodiment, the OCB LCD panel 400 further includes an alignment film 450 disposed on the active device array substrate 410 and the opposite substrate 420. Moreover, the alignment film 450 may cover the patterned dielectric layer 440.

In addition, the opposite substrate 420 includes a black matrix layer 422 and a plurality of color filters 424, and the patterned dielectric layer 440 may have at least a concave 460 disposed corresponding to the black matrix 422. The opposite substrate 420 may have a common electrode 426 covering the patterned dielectric layer 440. In another embodiment, the concave 460 may also be disposed corresponding to the color filters 424.

It should be noted that the concave 460 of the present invention has the same function and profile features with that of the first concave 260 and the second concave 360 of the above two embodiments, and the related description thereof is omitted. The concave 460 is designed for providing a transition core for the OCB liquid crystal molecules, such that when the display panel is driven, the display panel may rapidly enter a display state.

In summary, the OCB LCD panel of the present invention has at least the following advantages:

1. In the OCB LCD panel of the present invention, the transition core for the OCB liquid crystal molecules is provided based on the design of the patterned dielectric layer, such that the liquid crystal molecules may be rapidly and fully transited into the display state.

2. In the OCB LCD panel of the present invention, fabrication process of the patterned dielectric layer is compatible to current fabrication process.

3. In the OCB LCD panel of the present invention, the transition surface may be disposed within the non-display regions, and therefore the display effect of the display regions will not be affected, and reduction of aperture ratio is improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An optically compensated bend (OCB) liquid crystal display (LCD) panel, comprising:
an active device array substrate;
an opposite substrate, disposed opposite to the active device array substrate;
an OCB liquid crystal layer, disposed between the active device array substrate and the opposite substrate;
a first patterned dielectric layer, disposed on the active device array substrate, wherein the first patterned dielectric layer comprises at least a first concave and at least a first transition surface corresponding to the first concave, and an arrangement of OCB liquid crystal molecules of the OCB liquid crystal layer above the first transition surface is a hybrid state, which is between a splay state and a bend state; and
an alignment film covering the first patterned dielectric layer

2. The OCB LCD panel as claimed in claim 1, wherein a shape of the first concave is strip.

3. The OCB LCD panel as claimed in claim 1, wherein the first concave comprises a plurality of first side surfaces, and a part of the first side surfaces is the first transition surface.

4. The OCB LCD panel as claimed in claim 3, wherein a first angle is formed between the first side surfaces and the active device array substrate, and the first angle is an acute angle.

5. The OCB LCD panel as claimed in claim 4, wherein the first angle is around 60 degree.

6. The OCB LCD panel as claimed in claim 4, wherein a shape of the first side surface is arc.

7. The OCB LCD panel as claimed in claim 4, wherein the active device array substrate comprises a plurality of display regions and a plurality of non-display regions located outside the display regions, and the first concaves are disposed within the display regions or the non-display regions.

8. The OCB LCD panel as claimed in claim 7, wherein the active device array substrate comprises a plurality of scan lines, a plurality of data lines, a plurality of active devices and a plurality of pixel electrodes electrically connected to the active devices, the scan lines, the data lines and the active devices are disposed within the non-display region, the first concave is disposed corresponding to at least one of the scan lines and the data lines, and the pixel electrodes cover a part of the first side surfaces.

9. The OCB LCD panel as claimed in claim 8 further comprising a light-shielding pattern disposed on the active device array substrate or the opposite substrate, wherein the light-shielding pattern is located at both sides of the scan lines or the data lines.

10. The OCB LCD panel as claimed in claim 7, wherein the active device array substrate further comprises at leas a storage capacitor disposed within the non-display regions, and a part of the first concaves are disposed corresponding to the storage capacitors.

11. The OCB LCD panel as claimed in claim 7, wherein the opposite substrate comprises a black matrix layer and a plurality of color filters, the black matrix layer is disposed corresponding to the non-display regions, and the color filters are disposed corresponding to the display regions.

12. The OCB LCD panel as claimed in claim 11 further comprising a second patterned dielectric layer disposed on the opposite substrate, wherein the second patterned dielectric layer has at least a second concave disposed corresponding to the black matrix layer or the color filters.

13. The OCB LCD panel as claimed in claim 12, wherein the opposite substrate comprises a common electrode disposed on the second patterned dielectric layer.

14. The OCB LCD panel as claimed in claim 12, wherein the second concaves comprise a plurality of second side surfaces, and a part of the side surfaces form at least one second transition surface.

15. The OCB LCD panel as claimed in claim 14, wherein a second angle is formed between the second side surfaces and the opposite substrate, and the second angle is an acute angle.

16. The OCB LCD panel as claimed in claim 14, wherein a shape of each of the second side surfaces is arc.

17. The OCB LCD panel as claimed in claim 12, wherein a shape of each of the second concaves is strips.

18. An OCB LCD panel, comprising:
an active device array substrate;
an opposite substrate, disposed opposite to the active device array substrate;
an OCB liquid crystal layer, disposed between the active device array substrate and the opposite substrate; and
a patterned dielectric layer, disposed on the opposite substrate, wherein the patterned dielectric layer comprises at least a concave and at least a transition surface corresponding to the concave, and an arrangement of OCB liquid crystal molecules of the OCB liquid crystal layer above the transition surface is a hybrid state, which is between a splay state and a bend state.

19. The OCB LCD panel as claimed in claim 18 further comprising an alignment film disposed on the active device array substrate and the opposite substrate, wherein the alignment film covers the patterned dielectric layer.

20. The OCB LCD panel as claimed in claim 18, wherein the opposite substrate comprises a black matrix layer and a plurality of color filters, and the concaves are disposed corresponding to the black matrix layer or the color filters.

21. The OCB LCD panel as claimed in claim 18, wherein the concave comprises at least a side surface, and a part of the side surfaces is the transition surface.

22. The OCB LCD panel as claimed in claim 21, wherein an angle is formed between each of the side surfaces and the opposite substrate, and the angle is an acute angle.

23. The OCB LCD panel as claimed in claim 21, wherein a shape of each of the side surface is arc.

24. The OCB LCD panel as claimed in claim 18, wherein a shape of the concave is strip.

25. The OCB LCD panel as claimed in claim 18, wherein the opposite substrate comprises a common electrode covering the patterned dielectric layer.
